(19) United States
(12) Patent Application Publication
(10) Pub. No.: US 2014/0373348 A1
(43) Pub. Date: Dec. 25, 2014

(54) RETROFIT LED BILLBOARD ILLUMINATION SYSTEM

(71) Applicant: Wavien, Inc., Valencia, CA (US)

(72) Inventor: Kenneth LI, Castaic, CA (US)

(21) Appl. No.: 14/310,027

(22) Filed: Jun. 20, 2014

Related U.S. Application Data
(60) Provisional application No. 61/837,249, filed on Jun. 20, 2013.

(51) Int. Cl. F21K 99/00; G09F 13/22

(52) U.S. Cl. CPC F21K 9/10; F21K 9/90; G09F 13/22; G09F 2013/222
USPC 29/834

(57) ABSTRACT

A method for retrofitting a billboard system illuminated by an arc lamp which includes a reflector with reflector features and an output lens includes the steps of removing the lens from the arc lamp housing, mapping the light pattern output of the arc lamp, and then removing the arc lamp and reflector from the housing. Next, a plurality of LEDs is mounted on an LED circuit board in a pattern so that light output by the LEDs replicates the light pattern of the arc lamp, including the reflected light. The circuit board is then installed inside the housing, and the lens is reattached. Preferably, the LEDs include a central LED cluster of densely packed LEDs to replicate the original output of the arc and a pair of LED groups of less densely packed LEDs, located on either side of the LED cluster, to replicate the output from the reflector. If desired, some of the LEDs may be oriented at an angle relative to the circuit board to help replicate more precisely the original output of the arc lamp which may include light that is reflected by interior surfaces of the arc lamp housing and not directly emitted from the arc or reflector.

### CROSS-REFERENCE TO RELATED APPLICATIONS

The present application claims priority on U.S. provisional patent application No. 61/837,249, filed on Jun. 20, 2013.

### BACKGROUND OF THE INVENTION

Outdoor billboards represent an important media for advertising goods and services. Typically, large outdoor billboard systems are placed next to highways and other major roads to be visible to passing traffic. Since a large portion of traffic may pass by the billboard after dark, it is important to provide a nighttime illumination system. Known illumination systems are designed to illuminate the billboard brightly, so that passing cars can easily read the billboard, and to create the billboard lighting which displays the advertising in a desirable manner

Traditional billboard illumination systems use metal halide arc lamps. The lamps are contained in a lamp housing. Typically, a large billboard is illuminated by two or more lamps which are supported by arms extending from the billboards, so that each lamp is positioned in front of, and slightly below, the billboard (i.e., so as not to block the line of vision from passengers to the billboard display). Since different regions of the billboard are located at different distances from the light sources, the lamp housing includes a reflector and a lens for directing light from the lamp onto the billboard with high efficiency and uniformity.

FIG. 1 shows a standard (e.g., 48 foot×14 foot) billboard 10 with typical known billboard illumination system. The known system has three arc lamp units 12a, 12b, and 12c which are mounted on arms 14 (only one of which is shown) so as to be positioned in front of, and slightly below, the billboard 10. Each lamp unit 12a-12c illuminates an area A1, A2, or A3 of the billboard so that, combined, the entire billboard 10 is lit.

FIG. 2 shows a typical lamp unit 12a having a housing 16 containing an arc lamp 18 inside the housing 16. The arc lamp 18 is controlled by a power source 17 to generate an arc 19 which acts as the light source. A lens 20, which is also referred to as a refractor, usually forms the front cover 22 (i.e., facing the billboard 10) of the housing 16. Light from the arc 19 will be directed to the billboard 10 through the lens 20, which collects light efficiently and directs it to the billboard 10 with maximum uniformity. The lens 20 can take many shapes, such as concave or convex. More commonly, the lens 20 has a complex pattern of grooves and prisms formed on different regions of the lens surface, directing light to various areas of the billboard 10 for maximum uniformity and brightness.

The lamp unit housing 16 also contains a reflector element 24 on the side of the housing opposite to the lens 20. Light emitted by the arc 19 in the direction away from the lens 20 will strike the reflector element 24 and be reflected back towards the lens 20 and billboard 10. The reflector element 24 may be concave or convex, or may have other, free form shapes and features.

A simple reflector element 24 with smooth surfaces will reflect the light. However, the simple reflection of light by the reflector element 24 does not take full advantage of the lens 20 for maximizing efficiency and uniformity on the surface of the billboard 10. For such reasons, as shown in FIG. 3, the reflector element 24 contains reflector features 26, which may be convex or concave ridges, dimples, other raised surfaces, etc. The reflector features 26 for each illumination system 12a are designed, together with the complex shape of the lens 20, to provide maximum efficiency and uniformity in lighting the billboard 10.

FIGS. 4a and 4b show the lamp 12a with the lens removed. As shown, light reaching the lens 20 (if it were present) includes a very bright spot of light coming directly from the arc 19 of the arc lamp 18. The lens 20 also receives the output 34 of the reflector 24, including the reflector features 26, which are the result of the reflection of light emitted by the arc 19 reflected by the reflector element 24. Thus, the light pattern reaching the lens depends on the shape of the reflector as well as the design of the reflector features 26.

More recently, billboard illumination systems have been introduced which use LEDs as the light source. LEDs have become substantially brighter, use less power, and have a longer life that halide arc lamps. LED lighting systems reduce the cost of operating billboards by lowering the amount of electricity usage and reducing the need for, or frequency of, replacing the lamp.

While there are benefits to replacing existing billboard illumination systems with LED illumination systems, there are drawbacks. Replacement requires removal of the existing halide arc lamp housing, which is usually very heavy. The new LED illumination system also needs to be designed with the same ruggedness as the old system in order to withstand severe weather conditions in many installations. And then there are the costs of replacing still working arc lamp systems with LED systems.

### SUMMARY OF THE INVENTION

The present invention is a retrofit LED system which is used to replace the traditional arc lamp lighting source. The invention retains and uses the original housing 16 and lens 20, while replacing the arc lamp 18, its associated electronics 17, and the reflector 24 with an LED array and appropriate control electronics, thus reducing the cost of the replacement system. The new LED array is designed with multiple LEDs such that the output light profile matches closely that of the original arc lamp and reflection system. The retrofitted light source makes use of the original lens to provide efficiency and uniform output of the illuminated billboard.

In a preferred embodiment, the invention is a method for retrofitting a billboard system illuminated by an arc lamp which includes a reflector with reflector features and an output lens. The method includes the steps of removing the lens from the arc lamp housing, mapping the light pattern output of the arc lamp, and then removing the arc lamp and reflector from the housing. Next, a plurality of LEDs is mounted on an LED circuit board so as to replicate the light pattern of the arc lamp. The circuit board is mounted inside the housing, and the lens is reinstalled.

Preferably, the LEDs include a central LED cluster of densely packed LEDs to replicate the original output of the arc and a pair of LED groups of less densely packed LEDs, located on either side of the LED cluster, to replicate the output from the reflector. If desired, some of the LEDs may be oriented at an angle relative to the circuit board to help replicate, or improve, the original output of the arc lamp.

### BRIEF DESCRIPTION OF THE DRAWINGS

FIG. 1 is a schematic view of a prior art billboard with lighting system;

FIGS. 2 and 3 are schematic drawings of a prior art lighting system for use with a billboard;

FIGS. 4a and 4b are schematic drawings of a prior art lighting system with the lens removed;

FIGS. 5a and 5b are schematic drawings of a conventional arc lamp light source which has been retrofitted with an LED lighting panel constituting a first embodiment of the invention;

FIGS. 6-7 are schematic drawings of LED lighting panels according to a second and third embodiments, respectively, of the invention;

FIGS. 8a-8d are schematic drawings of various examples of LED cluster configurations for use in a lighting panel according to the invention;

FIGS. 9-10 are schematic drawings of LED lighting panels according to a fourth and fifth embodiment of the invention.

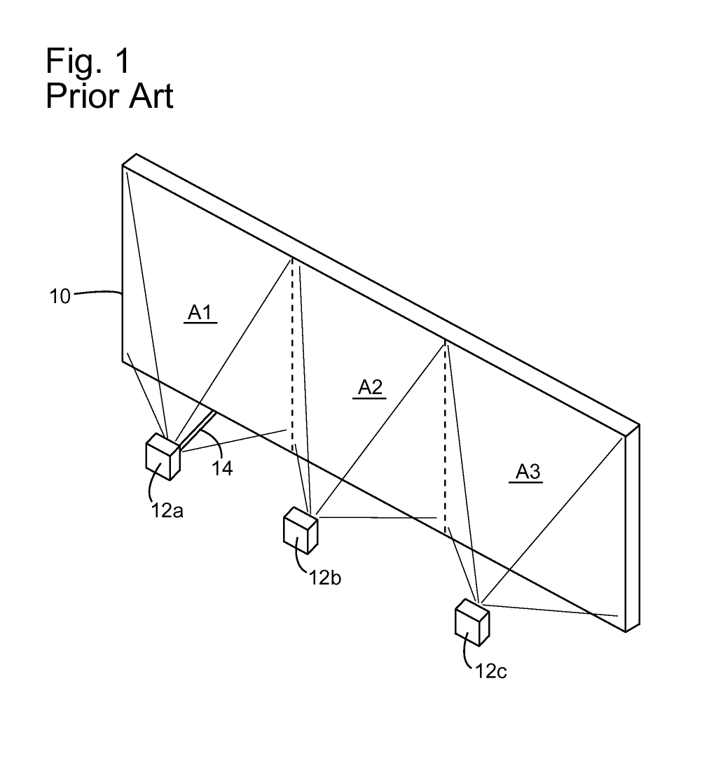

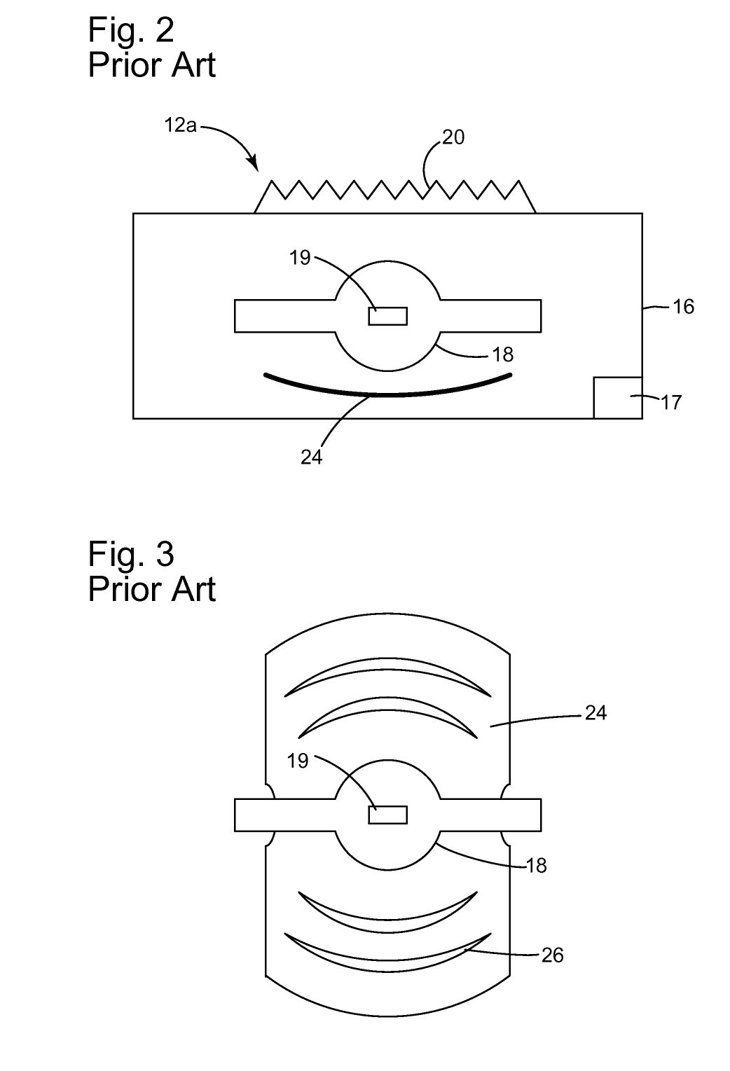

### DETAILED DESCRIPTION OF THE INVENTION

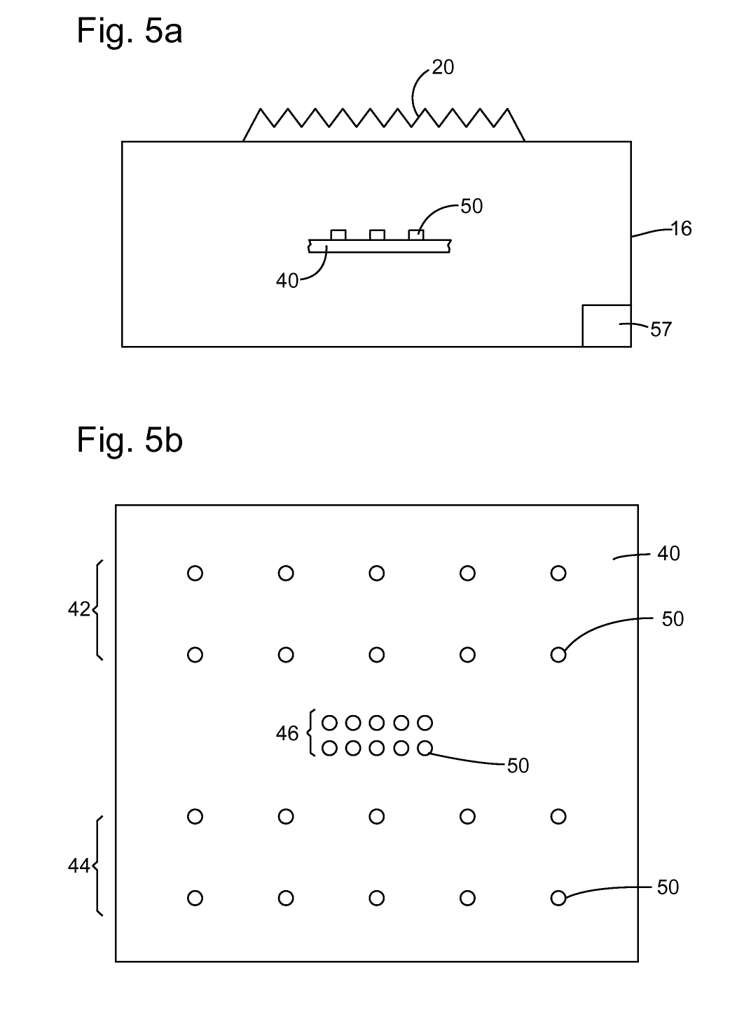

FIGS. 5a and 5b show an embodiment of the invention. The embodiment includes the original housing 16 and lens 20. The original arc lamp 18, electronics 17, and reflector 24 have been removed and replaced by LED circuit board 40 with LEDs 50 and LED control electronics 57.

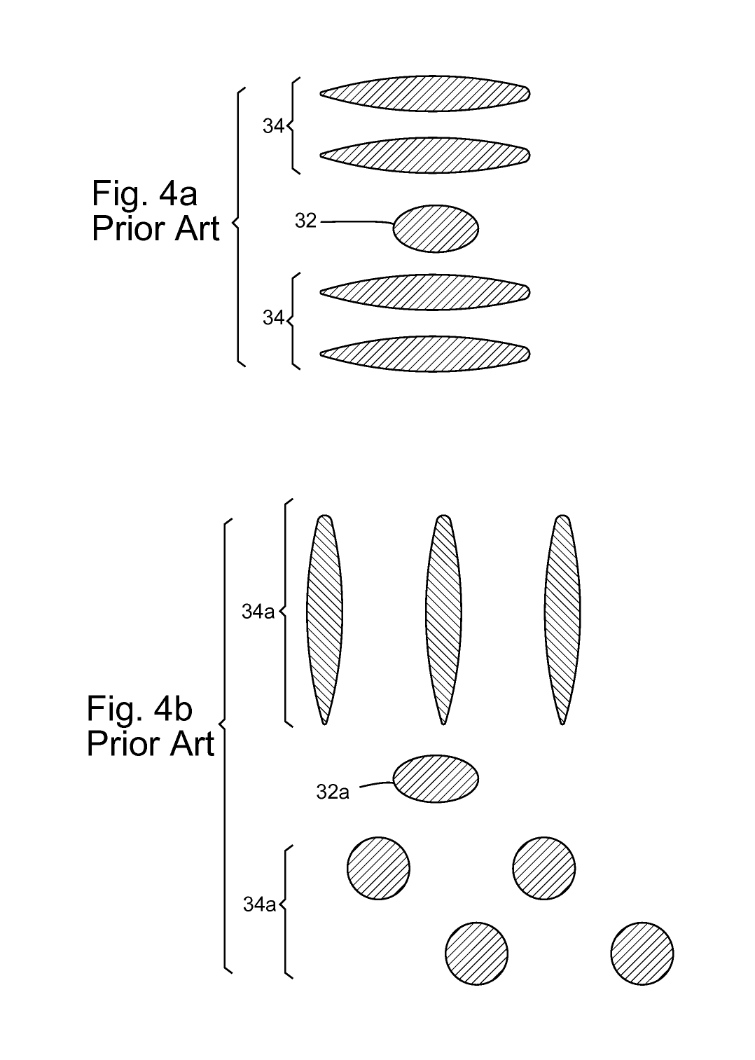

As shown in FIG. 5b, the LED circuit board 40 has three groups of LEDs: an upper group 42 and lower group 44 of LEDs, each group arranged in a pattern of LEDs to produce a light output replicating the reflector feature output 34 or 34a of the original arc lamp 18 and reflector 24, e.g., as shown in FIGS. 4a and 4b, respectively; and an LED cluster group 46 located between the upper and lower groups 42, 44 configured in a pattern of more densely packed LEDs 50 to produce a light output replicating the output 32 of the original arc lamp 18, e.g., as shown in FIGS. 4a and 4b.

By configuring the LEDs 50 on the LED circuit board 40 to replicate the output and light pattern on the original arc lamp 18 and reflector 24, including taking into account the original pattern of reflector features 26, the light output from the LED circuit board will be able to couple efficiently through the original lens 20 and illuminate the billboard 10 as efficiently and uniformly as the original system. And, because the number of LEDs and placement of the LEDs are very flexible, the retrofitted system may be further reconfigured to outperform the original system.

Replication of the light pattern of the original arc lamp is performed in the following manner. After removing the original lens 20 of the arc lamp to be retrofitted, in a preferred embodiment the opening is covered by a filter plate to reduce the intensity of the lamp output. The filter is preferably an optical attenuation filter, for example as manufactured by Schneider Optics in Hauppauge, New York. However, other types of glass or plastic filters may be used. With the arc lamp illuminated, the filtered image is photographed. Based on the image obtained, an LED pattern is devised which will closely replicate the intensity profile of the image, with reference to the light intensity at each location, bearing in mind that some of the reflected light may also have been reflected off of an interior surface of the housing and thus be emitted at an angle which is different from light emitted directly by the reflector. The orientation of certain LEDS can be adjusted to replicate light reflected at such different angles. Also, the image typically has lines of light, which are replicated by using closely spaced LEDs. Preferably, in designing the LED pattern to be used, it is assumed that approximately 50 percent of the generated light originates from the arc and that the remaining 50 percent originates from the reflector.

Other methods may be employed to map the light intensity. For example, the opening may be artificially divided into a plurality of small regions, or pixels, and a video camera may be used to scan the image of the opening. A light sensor may be used to measure the intensity at each pixel. A computer may then be used to assemble the data to form the map. In such alternative system, it may be desirable to use an optical filter with the camera but, depending upon the camera design, it may not be needed.

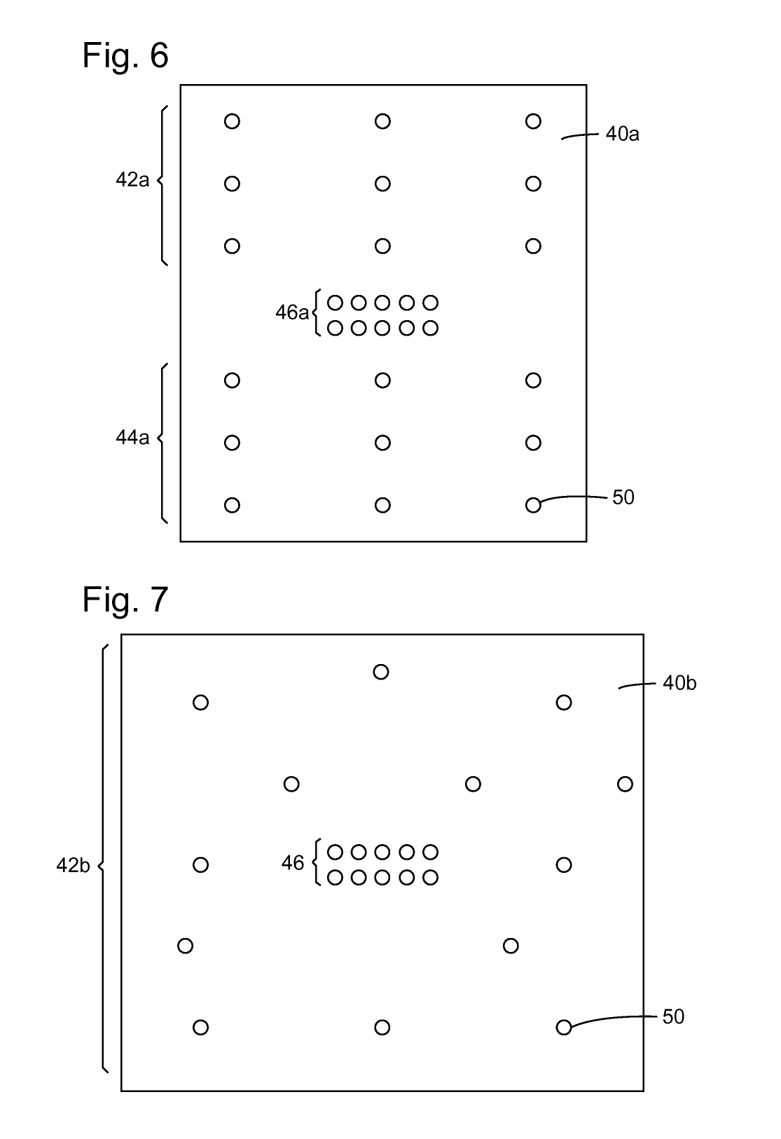

FIG. 6 shows an alternative circuit board 40a with the LED cluster 46 sandwiched between an upper 42a and lower 44a LED group. FIG. 7 shows another alternative circuit board 40b with the LED cluster 46 surrounded by an LED group 42b, in which the LEDs 50 can be at irregular spacings to replicate the original light pattern produced by the arc lamp 18 and reflector 24.

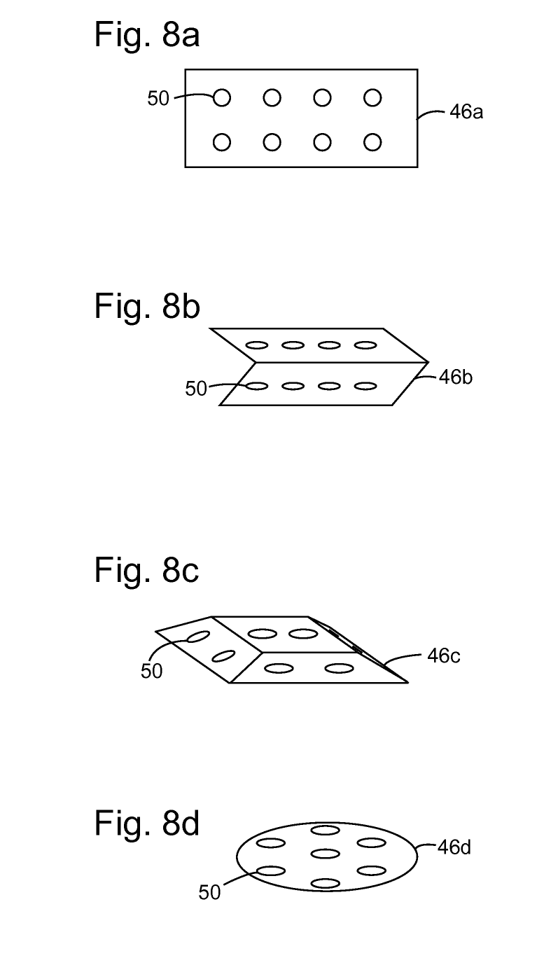

FIGS. 8a-8d show examples of various LED cluster designs including a cluster 46a in which LEDs 50 are contained on a flat surface; a cluster 46b in which LEDs are located on two surfaces 70, 71 which are angled relative to one another; a cluster 46c in which LEDs are mounted on a portion of an LED circuit board (or surface on top of the circuit board) having a pyramidal shape; or a cluster 46d in which the LEDs are mounted on a surface have a spherical or ellipsoidal shape.

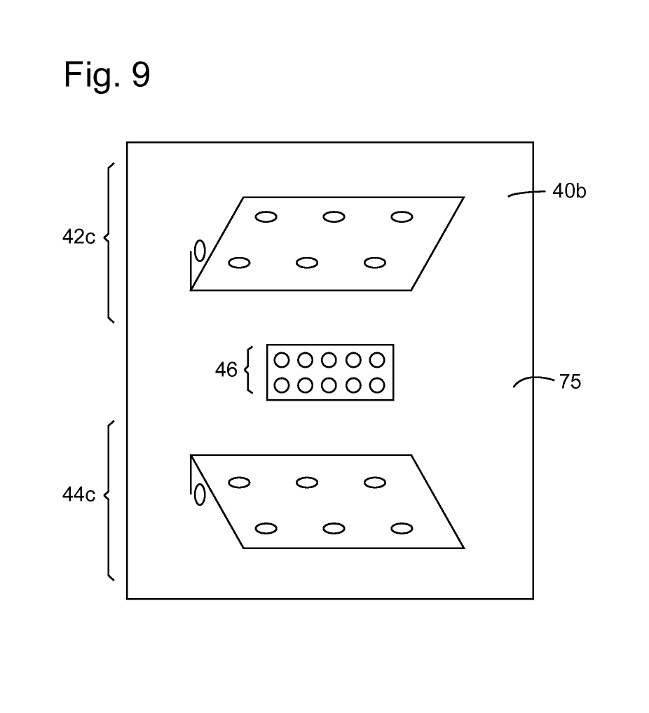

FIG. 9 shows another embodiment in which the LED groups 42c and 44c are above and below the LED cluster 46. Further, the LED groups 42c, 44c are placed on surfaces which are angled with respect to the upper surface 75 of the LED circuit board 40b. Preferably, the cluster 46 is flat relative to surface 75, but may be on an angled surface in order to better replicate the light pattern of the original arc lamp 18 and reflector member 24. The extra flexibility of angling the surfaces allows the replacement LED system to replicate very closely the original reflector output, increasing the efficiency and uniformity of the LED illumination system.

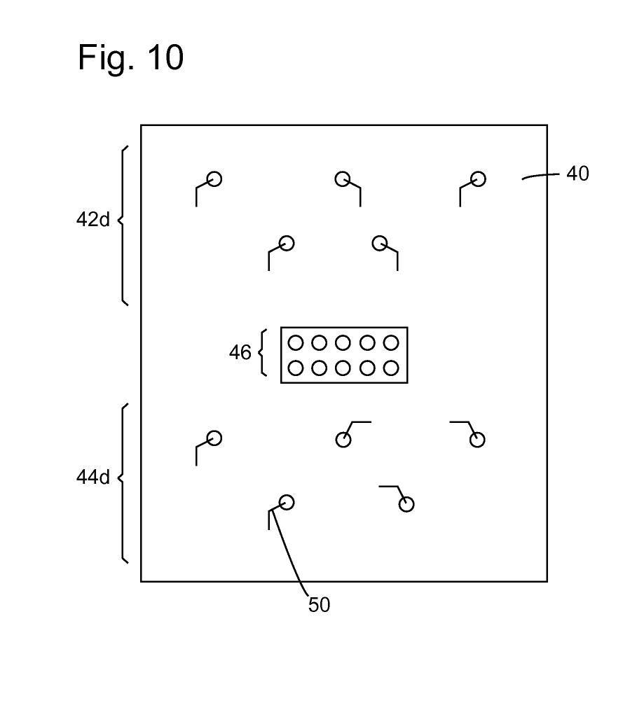

Finally, FIG. 10 shows yet another embodiment of the LED light source, in which one or more of the individual LEDs 50a on the circuit board, particularly the LED groups 42d and 44d, are placed in a desired location outside of the LED cluster 46 and pointed in an individual desired direction. Again, this provides additional flexibility to replicate the original light pattern on the lens 20 created by the arc lamp 18 and reflector 24.

In each of the embodiments described above, the power of each LED is adjusted to match the output intensity of the original arc/reflector output. For example, about 50 percent of the arc output is emitted toward the billboard 10 and, as a result, the LED cluster 46 will consume approximately 50 percent of the total system output. High powered LEDs will be needed. The remaining 50 percent of the arc output is emitted toward the reflector with a much larger area. As a result, the output from each reflector feature 26 will be small and will be replicated by an LED with lower power. Since the surface of the reflector is large and may have many features 26, many lower power LEDs can be used, positioned at the appropriate locations and angles for best replication of the original arc/reflector system.

For a lower cost system, the LEDs with the same driven current are preferably connected in series such that the cost of the power supply can be lowered. Low power LEDs with lower current drive requirements are preferably connected in parallel such that the total current requirements matches with the high power LEDs. This will allow the same LED driver to be used, lowering the cost of the system.

The LED cluster 46 in the center of the circuit board requires using more heat sink capacity than the LEDs in the LED groups outside the LED cluster. As a result, heat sinks with fins, heat pipes, heat cavities, and even fans may be required.

The foregoing description represents the preferred embodiments of the invention. Various modifications will be apparent to persons skilled in the art. All such modifications and variations are intended to be within the scope of the invention, as set forth in the following claims.

1. For use with a billboard system having a billboard and at least one arc lamp fixture for nighttime illumination, wherein the arc lamp fixture includes a housing, an arc lamp and a reflector, the arc lamp and reflector being disposed in said housing, wherein said housing includes an outlet covered by a lens, wherein said lens and the reflector are located on opposite sides of the arc lamp such that light emitted by the arc lamp in a direction away from said lens is reflected back towards said lens, wherein said reflector includes a plurality of reflector features for producing a predetermined light pattern directed towards said lens;
a method for converting said arc lamp fixture into an LED lamp fixture comprising the steps of:
(a) removing said lens from said housing;
(b) while illuminating said arc lamp, mapping the predetermined light pattern at various locations across the outlet;
(c) removing said arc lamp and said reflector from said housing;
(d) mounting a plurality of LEDs on an LED circuit board in a pattern such that the light output of the LEDs will replicate the predetermined light pattern;
(e) coupling said LEDs to LED control electronics;
(f) installing said circuit board inside said housing such that said LEDs emit light in the direction of the outlet; and
(g) reinstalling said lens.

2. The method of claim 1, wherein the LEDs are arranged to form a central LED cluster replicating the light output from the arc lamp and at least one LED group spaced from the LED cluster and replicating the light output reflected from the reflector.

3. The method of claim 1, wherein the LEDs are arranged to faun a central LED cluster replicating the light output from the arc lamp and a pair of LED groups, above and below, respectively, the LED cluster replicating the light output from the reflector, wherein the LEDs in the LED group are less densely configured than the LEDs in the LED cluster.

4. The method of claim 1, wherein said LED control electronics are used to modify the light output of at least some LEDs to help replicate the predetermined light pattern.

5. The method of claim 2, wherein said LED circuit board has a upper surface lying at least generally in a plane, and wherein at least some of the LEDs are mounted to emit light along an optic axis perpendicular to said plane.

6. The method of claim 5, wherein at least some other LEDs are mounted on surfaces to emit light along an optic axis which is not perpendicular to said plane.

7. The method of claim 6, wherein the LEDs of the LED cluster are mounted on two surfaces angled relative to one another.

8. The method of claim 7, wherein the LEDs of the LED cluster are mounted on surfaces having a pyramid shape.

9. The method of claim 6, wherein the LEDs of the LED cluster are mounted on a surface having a spherical or elliptical shape.

10. The method of claim 6, wherein at least some of the LEDs in the LED group are mounted on surfaces which are angled relative to said plane.

11. The method according to claim 10, wherein the LEDs in the LED cluster are mounted flat relative to the upper surface.

12. The method according to claim 1, wherein said LEDs comprise a combination of high power and lower power LEDs in order to replicate the predetermined light pattern more closely.

13. The method according to claim 12, wherein high power LEDs are connected in series with one another, and lower power LEDs are connected with one another in parallel.

14. The method according to claim 1, wherein the mapping step is done by placing a flat filter across the opening, to reduce the intensity of the image, and photographing the filtered image.

15. The method according to claim 14, wherein the filter is an optical attenuator filter.

16. The method according to claim 2, wherein the pattern of LED placement is designed by assuming that the LED cluster represents approximately one-half of the power generated by the are lamp and that said at least one LED group represents the remainder of the power generated by the arc lamp.
